(19) United States
(12) Patent Application Publication
(10) Pub. No.: US 2023/0259979 A1
(43) Pub. Date: Aug. 17, 2023

(54) FACILITATING IDENTIFICATION OF SENSITIVE CONTENT

(71) Applicant: ADOBE INC., San Jose, CA (US)

(72) Inventors: Irgelkha Mejia, Round Rock, TX (US); Robert William Burke, JR., Georgetown, TX (US); Ronald Eduardo Oribio, Austin, TX (US); Michele Saad, Austin, TX (US)

(21) Appl. No.: 17/670,753

(22) Filed: Feb. 14, 2022

(51) Int. Cl. G06Q 30/02; G06N 5/02

(52) U.S. Cl. CPC G06Q 30/0269; G06Q 30/0253; G06N 5/022

(57) ABSTRACT

Methods and systems are provided for facilitating identification of sensitive content. In embodiments described herein, a set of sensitive topics is obtained. Each sensitive topic in the set of sensitive topics can include subject matter that may be deemed sensitive to one or more individuals. Thereafter, the set of sensitive topics is expanded to an expanded set of sensitive topics using a first machine learning model. The expanded set of sensitive topics is used to train a second machine learning model to predict potential sensitive content in relation to input content.

### BACKGROUND

Marketers often desire to target or influence various individuals, for example, to achieve a conversion (e.g., a purchase of an item). While marketers may target various online consumers (e.g., shoppers), the online consumers are often unable to control the extent to which experiences are personalized, thereby often receiving undesired advertisements or other content. Receiving such undesired advertisements, or other content, can be frustrating to online consumers, thereby reducing consumer satisfaction as well as impacting revenue or success to the marketer (e.g., decrease in conversions).

### SUMMARY

Accordingly, embodiments of the present disclosure are directed to facilitating identification of sensitive content. Upon identifying sensitive content, a notification associated therewith can be provided to the content publisher. Accordingly, the content publisher can reassess the content and modify the content as appropriate. To facilitate identification of sensitive content, a machine learning model can be used to analyze content (e.g., marketing content) and predict whether the content includes sensitive subject matter. In embodiments, the machine learning model is trained using a set of sensitive topics. In addition to predicting whether content includes sensitive subject matter, embodiments described herein can monitor audience segment movement. In this regard, behavior or interactions associated with audience members can be monitored in association with deployment or launching of the content. In accordance with identifying sensitive content and/or audience segment movement, such information can be communicated to a publisher of the content (e.g., the marketer) such that the content publisher can reassess and/or revise the content in relation to sensitive content. Further, such information can additionally or alternatively be used as feedback to more robustly train the machine learning model used to identify sensitive content.

### BRIEF DESCRIPTION OF THE DRAWINGS

FIG. 1 depicts a diagram of an environment in which one or more embodiments of the present disclosure can be practiced, in accordance with various embodiments of the present disclosure.

FIG. 2 depicts an example configuration of an operating environment in which some implementations of the present disclosure can be employed, in accordance with various embodiments of the present disclosure.

FIG. 3 provides an example flow diagram of facilitating identification of sensitive content, in accordance with embodiments of the present disclosure.

FIG. 4 is a process flow showing a method for facilitating identification of sensitive content, in accordance with embodiments of the present disclosure.

FIG. 5 is a process flow showing another method for facilitating identification of sensitive content, in accordance with embodiments of the present disclosure.

FIG. 6 is a process flow showing another method for facilitating identification of sensitive content, in accordance with embodiments of the present disclosure.

FIG. 7 is a block diagram of an example computing device in which embodiments of the present disclosure can be employed.

### DETAILED DESCRIPTION

Marketers often desire to target or influence various individuals, for example, to achieve a conversion (e.g., a purchase of an item). While marketers may target various online consumers (e.g., shoppers), the online consumers are often unable to control the extent to which experiences are personalized. This misalignment between the marketer and online consumers desires can be particularly notable and impactful when providing content that may be potentially sensitive to the online consumer. For example, an online shopper that has experienced a loss during pregnancy may be sensitive to displayed advertisements relevant to babies. As another example, an individual that contributed to a sensitive cause may become sensitive to excessive targeting for continued donations to similar causes. As such, receiving undesired advertisements, or other content, can be frustrating to online consumers, thereby reducing consumer satisfaction as well as impacting revenue or success to the marketer (e.g., decrease in conversions).

Currently, to address sensitive content, viewers of the content generally must manually override the sensitive material or rely on the content publisher to appropriately curate topics and content. Such a process is time consuming and oftentimes inaccurate (e.g., in terms of understanding sensitivities of individuals). Further, because of such inaccuracies, unnecessary computing resource utilization is used. For example, in accordance with presenting content deemed sensitive, more computing resources may be needed or used to achieve a certain outcome. For example, in attempting to achieve a desired conversion rate, more resources may be used to present content (e.g., via a server and at audience member devices) in order to achieve the desired conversion rate (as content viewers may be dismissive of the content, resulting in no conversions).

As such, embodiments of the present disclosure are directed to facilitating identification of sensitive content. In this regard, sensitive content can be efficiently and effectively removed from content to be, or being, published, thereby increasing consumer satisfaction, increasing the opportunity to result in a conversion (e.g., a product purchase), and improving brand value or recognition. Advantageously, identifying sensitive content and adapting content accordingly can reduce computing resources as more effective content can be displayed to viewers, thereby reducing computing resources needed to present sensitive content.

In operation, to facilitate identification of sensitive content, a machine learning model can be used to analyze content (e.g., marketing content) and predict whether the content includes sensitive subject matter. In embodiments, the machine learning model is trained using a set of sensitive topics. In some cases an initial set of sensitive topics (e.g., curated by a domain expert) is expanded using a machine learning model (e.g., a language model). Advantageously, expanding the initial set of sensitive topics provides a more robust and comprehensive set of sensitive topics for use in training the machine learning model that predicts sensitive topics. In addition to predicting whether content includes sensitive subject matter, embodiments described herein can monitor audience segment movement. In this regard, behavior or interactions associated with audience members can be monitored, in association with deployment or launching of the content. In accordance with identifying sensitive content and/or audience segment movement, such information can be communicated to a publisher of the content (e.g., the marketer) such that the content publisher can reassess and/or revise the content in relation to sensitive content. Further, such information can additionally or alternatively be used as feedback to more robustly train the machine learning model used to identify sensitive content. For example, the feedback can be used to add to the list of sensitive topics used for training the model or to modify weights associated with sensitive topics used to trained the model. Advantageously, updating the sensitive topics, or weights associated therewith, enables a more dynamic approach to identifying sensitive content as content can have different levels of sensitivities and, further, can change over time (e.g., what was not sensitive to consumers last week is not sensitive this week).

Various terms are used throughout the description of embodiments provided herein. A brief overview of such terms and phrases is provided here for ease of understanding, but more details of these terms and phrases is provided throughout.

A sensitive topic generally refers to a topic, subject matter, text, or language that can be considered sensitive to an audience member(s). Sensitive topics can relate to any number of considerations, such as death, age, race, gender, religion, health-related issues, finances, costs, geographical considerations, politics, parenthood, etc.

Sensitive content refers to content that can be sensitive to a consumer(s) or potential consumer(s) of the content. Content can be related to marketing or advertising content, but is not limited thereto.

An audience member generally refers to an individual, such as a consumer, that can view and/or interact with content. An audience segment refers to a data segment or group (set of audience members) that have a common attribute or feature. Such common attributes can be demographic attributes, interest attributes, preference attributes, behavior attributes, and/or the like.

A user refers to an individual or entity that can provide content. In some cases, a user is a marketer or advertiser. Although a user is generally referred to herein as a marketer, that is for provided for exemplary purposes only.

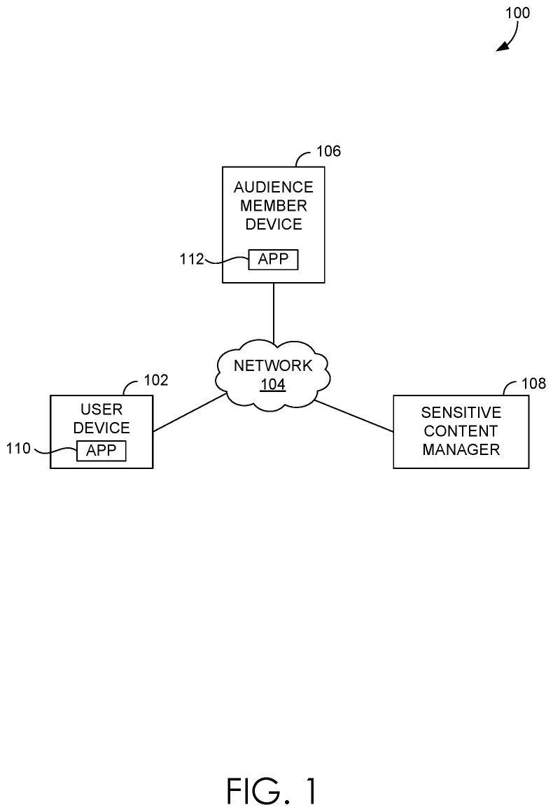

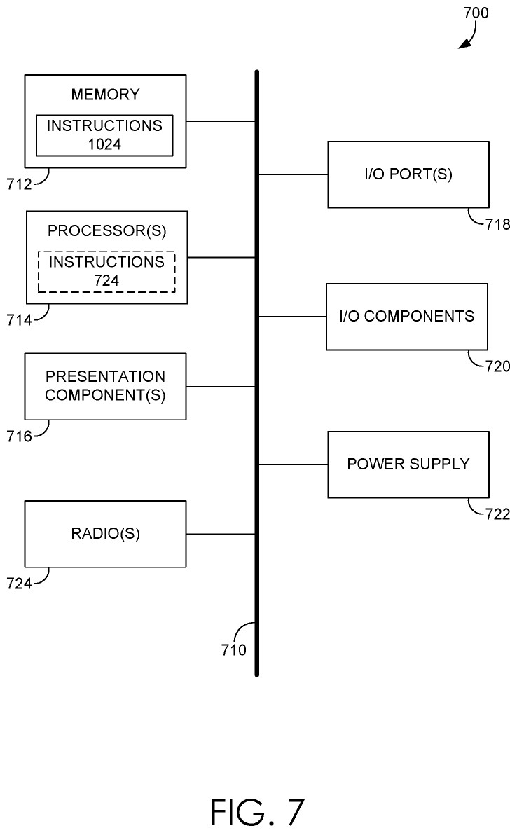

Turning to FIG. 1, FIG. 1 depicts an example configuration of an operating environment in which some implementations of the present disclosure can be employed. It should be understood that this and other arrangements described herein are set forth only as examples. Other arrangements and elements (e.g., machines, interfaces, functions, orders, and groupings of functions, etc.) can be used in addition to or instead of those shown, and some elements can be omitted altogether for the sake of clarity. Further, many of the elements described herein are functional entities that can be implemented as discrete or distributed components or in conjunction with other components, and in any suitable combination and location. Various functions described herein as being performed by one or more entities can be carried out by hardware, firmware, and/or software. For instance, some functions can be carried out by a processor executing instructions stored in memory as further described with reference to FIG. 7.

It should be understood that operating environment 100 shown in FIG. 1 is an example of one suitable operating environment. Among other components not shown, operating environment 100 includes a user device 102, network 104, audience member device 106, and sensitive content manager 108. Each of the components shown in FIG. 1 can be implemented via any type of computing device, such as one or more of computing device 700 described in connection to FIG. 7, for example. These components can communicate with each other via network 104, which can be wired, wireless, or both. Network 104 can include multiple networks, or a network of networks, but is shown in simple form so as not to obscure aspects of the present disclosure. By way of example, network 104 can include one or more wide area networks (WANs), one or more local area networks (LANs), one or more public networks such as the Internet, and/or one or more private networks. Where network 104 includes a wireless telecommunications network, components such as a base station, a communications tower, or even access points (as well as other components) can provide wireless connectivity. Networking environments are commonplace in offices, enterprise-wide computer networks, intranets, and the Internet. Accordingly, network 104 is not described in significant detail.

It should be understood that any number of user devices, servers, audience member devices, and other components can be employed within operating environment 100 within the scope of the present disclosure. Each can comprise a single device or multiple devices cooperating in a distributed environment.

User device 102 and audience member device 106 can be any type of computing device capable of being operated by an individual(s). For example, in some implementations, such devices are the type of computing device described in relation to FIG. 7. By way of example and not limitation, user devices and audience member devices can be embodied as a personal computer (PC), a laptop computer, a mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, any combination of these delineated devices, or any other suitable device.

The user device and audience member device can include one or more processors, and one or more computer-readable media. The computer-readable media may include computer-readable instructions executable by the one or more processors. The instructions may be embodied by one or more applications, such as application 110 and 112 shown in FIG. 1. Applications 110 and 112 are referred to as single applications for simplicity, but its functionality can be embodied by one or more applications in practice.

Application 112 operating on audience member device 106 can be any application with which an audience member interacts in association with content, for example, including marketing content. In embodiments, audience member interactions with application 112 can be monitored (e.g., via a server) to identify interactions of an audience members in association with content (e.g., marketing content). For example, in the context of a journey, progress of an audience member in association with a journey(s) can be identified based on interactions with application 112. A journey can include a set of one or more events, controls, and/or corresponding responses. To this end, a journey can include a sequence of events, controls, and/or responses through which audience members (e.g., individuals, customers) may traverse. An event refers to an event or action that is performed by a user. Generally, an event can be an action performed or detected via a computer (i.e., computer-based events). Examples of computer-based events include selecting or clicking on a particular product, electronically purchasing a particular product, navigating to a particular website, entering and/or existing a retail brick-and-mortar store, and the like. A control generally refers to some control or management of a response based on an event (e.g., timing of response, condition for a response, etc.). A response refers to any response or action provided in response to the event performed by the user. A response can be, for example, an electronic communication providing information related to the event in which the user participated. For example, an electronic communication can be related to a product associated with an event. Although events and responses are generally described herein as being electronically performed or detected, embodiments described herein are not intended to be limited hereto. For instance, a communication can be sent via the mail to provide a response in association with an event performed by a user, or an action taken by a user.

Application 110 operating on user device 102 can generally be any application capable of facilitating the exchange of information between the user devices and the sensitive content manager 108 in carrying out identification of sensitive content. In some implementations, the application(s) comprises a web application, which can run in a web browser, and could be hosted at least partially on the server-side of environment 100. In addition, or instead, the application(s) can comprise a dedicated application. In some cases, the application is integrated into the operating system (e.g., as a service). It is therefore contemplated herein that “application” be interpreted broadly.

In accordance with embodiments herein, the application 110 can facilitate identification of sensitive content. In operation, a user can provide content (e.g., marketing content) via a graphical user interface provided via the application 110. The sensitive content manager 108 can identify content that may be sensitive to one or more audience members or potential audience members. In this regard, the sensitive content manager 108 can identify content that may be sensitive to a consumer or potential consumer of the content and provide such information to application 110 of the user device. The identified sensitive content can be displayed via a display screen of the user device. The identified sensitive content can be presented in any manner.

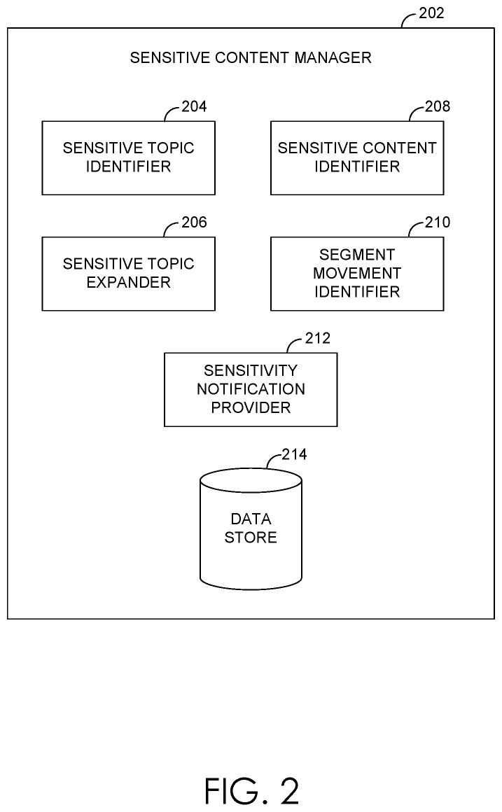

As described herein, sensitive content manager 108 can facilitate identifying and providing sensitive content. Sensitive content manager 108 can be or include a server, including one or more processors, and one or more computer-readable media. The computer-readable media includes computer-readable instructions executable by the one or more processors. The instructions can optionally implement one or more components of sensitive content manager, described in additional detail below with respect sensitive content manager 202 of FIG. 2. At a high level, sensitive content manager 108 can identify content that may be sensitive to one or more audience members or potential audience members. In this regard, the sensitive content manager 108 can identify content that may be sensitive to a consumer or potential consumer of the content and provide such information to application 110 of the user device. The identified sensitive content can be displayed via a display screen of the user device. The identified sensitive content can be presented in any manner.

For cloud-based implementations, the instructions on sensitive content manager 108 can implement one or more components, and application 110 can be utilized by a user to interface with the functionality implemented on sensitive content manager 108. In some cases, application 110 comprises a web browser. In other cases, sensitive content manager 108 may not be required. For example, the components of sensitive content manager 108 may be implemented completely on a user device, such as user device 102. In this case, sensitive content manager may be embodied at least partially by the instructions corresponding to application 110.

Thus, it should be appreciated that sensitive content manager 108 may be provided via multiple devices arranged in a distributed environment that collectively provide the functionality described herein. Additionally, other components not shown may also be included within the distributed environment. In addition, or instead, sensitive content manager 108 can be integrated, at least partially, into a user device, such as user device 102, and/or audience member device, such as audience member device 106. Furthermore, sensitive content manager 108 may at least partially be embodied as a cloud computing service.

Referring to FIG. 2, aspects of an illustrative sensitive content management system are shown, in accordance with various embodiments of the present disclosure. At a high level, a sensitive content manager can manage sensitive content. In particular, sensitive content manager can identify sensitive content, for example, provided by a user, such as a marketer. In this regard, the sensitive content manager can determine and provide (e.g., in real time) sensitive content notifications. As described herein, content refers to any type of electronic content. Such electric content may be in the form of text, images, and/or videos. Although examples of content are generally provided herein in relation to marketing materials, embodiments of the present technology are not limited herein. Sensitive content refers to content that may be considered sensitive to a viewer of the content. In some cases, sensitive content may be identified as sensitive to some viewers (e.g., one audience segment), while not identified as sensitive to other views (e.g., another audience segment).

As shown in FIG. 2, sensitive content manager 202 can include a sensitive topic identifier 204, a sensitive topic expander 206, a sensitive content identifier 208, a segment movement identifier 210, a sensitivity notification provider 212, and a data store 214. The foregoing components of sensitive content manager 202 can be implemented, for example, in operating environment 100 of FIG. 1. In particular, those components may be integrated into any suitable combination of user devices 102, audience member devices 106, and/or sensitive content manager 108.

Data store 214 can store computer instructions (e.g., software program instructions, routines, or services), data, and/or models used in embodiments described herein. In some implementations, data store 214 stores information or data received or generated via the various components of sensitive content manager 202 and provides the various components with access to that information or data, as needed. Although depicted as a single component, data store 214 may be embodied as one or more data stores. Further, the information in data store 214 may be distributed in any suitable manner across one or more data stores for storage (which may be hosted externally).

In embodiments, data stored in data store 214 includes sensitive topics, expanded sensitive topics, models, audience member data (e.g., characteristics, behavior or interaction data, etc.), sensitivity notifications, training data, and/or the like. In some cases, sensitive content manager 202, or components associated therewith, can obtain data from client devices (e.g., a user device(s), audience member device(s), etc.). In other cases, data can be received from one or more data stores in the cloud, or data generated by the sensitive content manager 202.

The sensitive topic identifier 204 is generally configured to identify sensitive topics. A sensitive topic generally refers to a topic, subject matter, text, or language that may be considered sensitive to an audience member(s). Sensitive topics can relate to any number of considerations, such as death, age, race, gender, religion, health-related issues, finances, costs, geographical considerations, politics, parenthood, etc. Further, sensitive topics can be any level of granularity. For example, a sensitive topic can be a generalization of a subject matter, or a specific instance or details associated with a subject matter.

Sensitive topics can be identified in any number of ways. In some embodiments, sensitive topics are identified based on human input. In this regard, a human(s) (e.g., a domain expert) can manually curate an initial list of sensitive topics. For example, a set of marketers or other set of individuals can provide or input a list of topics deemed sensitive.

Additionally or alternatively, sensitive topics can be identified based on audience member indications (e.g., based on interactions) and/or feedback. For example, in some cases, an audience member provides a direct indication that a topic is deemed sensitive in relation to the audience member or a set of audience members (e.g., via a website or user profile). As another example, an audience member(s) may provide interactions with content indicating a sensitive topic. For example, as content or topics are presented via a graphical user interface to a set of audience members, topics that resulted in a negative effect based on the audience member(s) interactions or behavioral data may be identified. In this way, as a user interacts with a merchant's website in a way that results in a negative effect (e.g., an audience member not revising the website, not purchasing an item or otherwise not performing a conversion, selecting or flagging an ad as “never show this to me again,” etc.), a sensitive topic can be identified. To this end, interaction or behavioral data associated with an audience member or set of audience members may be analyzed and used to identify sensitive topics. Using audience member behavior to identify sensitive topics may be performed in any number of ways, including using machine learning to identify sensitive topics based on the behaviour. Upon identifying sensitive topics based on analysis of audience member behavior, such identified topics may, in some cases, be manually curated by a human.

As described, feedback can also be used to identify sensitive topics. Feedback may be provided in any number of forms. As one example, and as described in more detail below, sensitive content identifier 208 may identify sensitive content. In such cases, the sensitive content may be provided (e.g., in some cases with additional data, such as a probability associated with the sensitive content) as feedback to the sensitive topic identifier 204, which can then use feedback to enhance the set of sensitive topics. As another example, segment movement identifier 210 may provide an indication of content associated with audience segment movement (e.g., unexpected audience segment movement). Such feedback can then be used by the sensitive topic identifier 204 to enhance the set of sensitive topics.

In some embodiments, the sensitive topics may be weighted. Weightings associated with sensitive topics may be provided in any number of ways. As one example, a user, such as a marketer or domain expert may provide input (e.g., via a graphical user interface) indicating desired weights for sensitive topics. In other cases, weights may be provided in connection with feedback received. For instance, the sensitive content identifier 208 and/or segment movement identifier 210 may provide an indication of a particular sensitive topic (e.g., identified via analysis of content) and a probability associated therewith. Such a probability may be based on, for example, analysis performed via a machine learning algorithm, an amount of audience segment movement, an overlap of an identification of sensitive content with audience segment movement, and/or the like.

Using weightings can be valuable as topics may have different levels of sensitivities. For instance, one topic may be more sensitive to audience members than another topic. Further, sensitivities may change over time. For example, due to current external or environmental factors, one topic may be currently more sensitive than at a previous point in time. As can be appreciated, the sensitive topic identifier 204 may store the initial set of sensitive topics and/or corresponding weights via a data store, such as data store 214.

The sensitive topic expander 206 is generally configured to expand the set of sensitive topics (e.g., initial set of topics). In this regard, the sensitive topic expander 206 may supplement the set of sensitive topics identified via sensitive topic identifier 204 to generate a more comprehensive set of sensitive topics. The sensitive topic expander 206 may expand a set of sensitive topics in any number of ways.

In some embodiments, the sensitive topic expander 206 may use topic expansion logic 220 to expand a set of topics. Topic expansion logic 220 may include rules, conditions, associations, models, algorithms, or the like to generate an expanded list of sensitive topics. Topic expansion logic 220 may take on different forms depending on the mechanism used to determine an expanded list of sensitive topics. For example, topic expansion logic 220 may comprise a statistical model, fuzzy logic, neural network, finite state machine, support vector machine, logistic regression, clustering, or machine-learning techniques, similar statistical classification processes, or combinations of these to identify an expanded set of sensitive topics.

In one embodiment, the topic expansion logic 220 may be or include natural language processing. As one example, a language model may be used to perform sensitive topic expansion (e.g., via synonym expansion and/or related-term expansion). A language model generally refers to a statistical and probabilistic tool used to predict words. Such models look for patterns in the human language. Language models generally analyze text to provide a basis for text predictions. To this end, a language model may analyze an embedding space to identify words or phrases near or in a neighborhood of a given word/phrase representing an initial sensitive topic. By way of example only, assume a first initial sensitive topic is recognized. In such a case, a language model may be used to expand and identify more sensitive topics related to the first initial sensitive topic by analyzing the area around the first initial sensitive topic in the embedding space.

As can be appreciated, in some embodiments, a machine learning model may be specifically trained for use in expanding a list of sensitive topics. For example, a particular machine learning model may be trained to learn embeddings specific to sensitive topics. Such a machine learning model may be trained, for example, by feeding the model with articles or content related to sensitive topics.

The sensitive content identifier 208 is generally configured to identify sensitive content. As described, sensitive content refers to content that may be considered sensitive to a viewing audience member or set of audience members. In this regard, the sensitive content identifier 208 can obtain content to be analyzed for sensitive subject matter. Such content may be obtained in any number of ways. In some cases, content may be accessed via a data store, such as data store 214. For example, a data store may contain content for which sensitivity analysis is desired. In other cases, content may be provided via a user device, such as user device 102 of FIG. 1. For example, assume a marketer has content desired to be published. In such a case, the marketer may provide the content (e.g., associated with an advertisement campaign), or an indication thereof, to the sensitive content manager 202 via a user device.

Upon obtaining content, the sensitive content identifier 208 can analyze the content to identify whether it includes any sensitive content (e.g., text, images, etc.). In some embodiments, the content being analyzed can be segmented (e.g., via a machine learning component). To identify sensitive content, the sensitive content identifier 208 can use a set of sensitive topics, such as an expanded set of sensitive topics as identified via sensitive topic expander 206. In this way, the content can be analyzed to identify whether any language, for example, is similar to or corresponds with any identified sensitive topic. In cases in which at least a portion of the content is identified as similar or related to an identified sensitive topic, the content, or content portion, can be identified as being sensitive.

In some embodiment, the sensitive content identifier 208 can use sensitivity logic 220 to identify sensitive content. Sensitivity logic 220 can include rules, conditions, associations, models, algorithms, or the like to generate an expanded list of sensitive topics. Sensitivity logic 220 can take on different forms depending on the mechanism used to determine sensitive content. For example, sensitivity logic 220 can comprise a statistical model, fuzzy logic, neural network, finite state machine, support vector machine, logistic regression, clustering, or machine-learning techniques, similar statistical classification processes, or combinations of these to identify sensitive content.

In embodiments, sensitivity logic 220 can be or include a machine learning model trained to detect sensitive content. Generally, the machine learning model can take content (e.g., related to an advertisement campaign) as input and output predictions related to whether the content includes potential sensitive content. Content sensitivity can be recognized in any number of ways. For example, portions of content can be identified in association with a probability of such sensitivities. By way of example only, one portion of content can be identified with a probability of including a sensitivity related to a sensitive topic, while another portion of content can be identified with a probability of including a sensitivity related to another sensitive topic. In other cases, content sensitivity can be reflected using a prediction for the entire content. For example, for a particular content, a probability of including sensitive subject matter can be predicted. As another example, for a particular content, a probability of including a first sensitive topic, a probability of including a second sensitive topic, and so on, can be determined. Any number of implementations can be used and is not intended to limit the scope of embodiments of the present technology.

To train a machine learning model to identify sensitive content, a set of identified sensitive topics, such as an expanded list of sensitive topics, can be used to train the model. As described in more detail below, feedback can be further provided to refine the machine learning model. For example, in some cases, sensitive content predicted or detected via the machine learning model can be provided as feedback to further refine the model. For instance, identified sensitive content can be provided to sensitive topic identifier 204 to update the list of sensitive topics (e.g., add a new topic), which is then used to update the model.

As another example, feedback from the segment movement identifier 210 and/or the sensitivity notification provider 212 (or other component or device) can be provided to the machine learning model to further refine the model. Such feedback, from components or users, can be used as input to refine the model or additionally or alternatively be used to provide or modify various weights. For example, particular sensitive topics can be weighted more or less based on content identified as sensitive and/or recognition of segment movement in accordance therewith. Updating weights of sensitive topics input to the machine learning model can thereby refine the training of the model.

As can be appreciated, although feedback can be specific to a particular content, brand, or product, using such feedback to fine tune a machine learning model can be advantageous across many industries or verticals. By way of example only, assume a marketing campaign content is directed to valentine's day. Further assume that the company's launch was not successful and corresponding feedback is provided. The feedback received from that campaign can be used to refine machine learning such that the information can inform other campaign content provided by another company.

The sensitive content identifier 208 can indicate sensitive content in any number of ways. For example, sensitive content identifier 208 can indicate an entire content as sensitive (e.g., a content contains sensitive information or a content does not contain sensitive information) or a specific portion(s) of content that is sensitive. Further, a particular sensitive topic(s) related to a specific portion of content or the entire content can be indicated. Such identified sensitive content can be indicated or recognized using text, annotations, flags, highlighting, etc. For example, in cases that sensitive content is identified, the content can be flagged as such.

The segment movement identifier 210 is generally configured to identify audience segment movement. As described, an audience segment generally refers to a data segment or group (set of audience members) that have a common attribute or feature. Such common attributes can be demographic attributes, interest attributes, preference attributes, behavior attributes, and/or the like. An audience member refers to an individual, consumer, shopper, etc. that views and/or interacts with content presented via a computing device (e.g., via a website). Audience segment movement generally refers to a movement of an audience member(s). In some cases, audience segment movement can refer to moving from one audience segment to another audience segment. In other cases, audience segment movement can refer to movement or shifts in association with an audience segment. Audience segment movement (e.g., movement from one audience segment to another) can occur based on interactions or engagement of an audience member(s), modification of attributes, etc. For example, as an audience member progresses in age or preferences, the audience member can move from one audience segment to another. As another example, as an audience member's behavior data changes, the audience member can move from one audience segment to another. In embodiment, the audience segments can be predefined (e.g., from a marketer).

Generally, audience segment movement is identified in accordance with a content publication (e.g., an advertisement campaign launch). In this regard, audience segment movement occurring in accordance with or upon publishing content can be identified. Advantageously identifying audience segment movement can provide information related to audience sensitivities. For example, in cases in which multiple audience members modify behaviors after a marketing campaign is launched (e.g., discontinue purchasing products), such behavioral modification might indicate sensitive content.

As audience segment movement can be naturally expected, in some embodiments, audience segment movement is identified by comparing actual audience segment movement to an expected audience segment movement. When the actual audience segment deviates from the expected audience segment movement, audience segment movement can be identified. In some cases, a movement threshold can be used to identify the actual audience segment deviates a threshold amount (e.g., a statistically significant deviation) from the expected audience segment movement, thereby indicating a movement associated with an audience segment.

Expected audience segment movement can be identified in any number of ways (e.g., via the segment movement identifier 210 or other component). In some cases, a publisher of content (e.g., marketer) can provide such expected audience segment movement. Such an expected audience segment movement can be provided to the sensitive content manager 108, for example, along with the content and stored in a data store, such as data store 214. An expected audience segment movement can be determined, for example, using a model (e.g., predetermined model) to identify expected movement from one audience segment to another audience segment. For example, a model can be used to identify that audience members initially belonging to a first audience segment are expected to move into a second audience segment (e.g., in accordance with publication of content).

Actual audience segment movement can be identified in any number of ways (e.g., via the segment movement identifier 210 or other component). As an example, audience segment movement can be identified by tracking based on interactions or engagement of an audience member(s), modification of attributes, etc. Based on audience member interactions or characteristics, an audience member can be moved from one audience segment to another (e.g., in accordance with audience segment definitions). Audience segment movement can be identified in accordance with a single audience member or a set of audience members. For instance, in some cases, the segment movement identifier 210 can identify statistically significant group movement of audience members between audience segments (e.g., following launch of an advertisement campaign).

In some cases, the segment movement identifier 210 can identify initiation of a publication of content (e.g., initiation of an ad campaign) and, thereafter, monitor audience segment movement. In other cases, the segment movement identifier 210 can continually monitor audience segment movement and correlate such movement with timing of published content. By way of example only, to assess correlation between audience member movement between audience segments and timing of content publication, audience member (e.g., shopper) movements between segments can be continuously monitored as a probabilistic temporal process. In this regard, audience members are assumed to belong to certain audience segments based on characteristics and can further be assumed to have certain expected movement between segments over time. Such movement can be modeled as a probabilistic temporal process with certain expected probabilistic behaviors. An onset of a content publication (e.g., campaign deployment) can be expected to trigger certain desired behaviors, such as, for example, increased click-through/conversion rates on an advertised set of products. In monitoring audience members, any statistically significant outlier or unexpected behavior upon content publication can be detected and trigger a flag.

Although generally described as audience movement from one segment to another segment, as can be appreciated, audience member movement can be generally identified and audience members need not actually move from one defined audience member segment to another audience member segment. In this regard, modifications of behaviors of audience members of an audience segment can be analyzed. For example, assume a content is published with an intent to target a particular audience segment. In such a case, the behavior of the audience members of that particular audience segment can be analyzed to identify changes. Such behavior modifications can reflect movement within the particular audience segment or to another audience segment (e.g., an audience segment that is inactive on the website).

The sensitivity notification provider 212 is generally configured to provide sensitivity notifications. A sensitivity notification generally refers to a notification related to sensitive content. In this regard, a sensitivity notification can provide an indication that a particular content can be sensitive in some manner.

In embodiments, the sensitivity notification provider 212 can generate a sensitivity notification to provide. To generate a sensitivity notification, the sensitivity notification provider 212 can use information generated by the sensitivity content identifier 208 and/or segment movement identifier 210. A sensitive notification can be in any number of formats, including use of texts, flags, icons, etc.

In some embodiments, the sensitivity notification provider 212 can generate a sensitivity notification based on sensitive content identified via the sensitive content identifier 208. In this way, the sensitivity notification can include an indication that a particular content is identified as potentially containing sensitive information, a particular portion of the content is identified as potentially containing sensitive information, a particular type of sensitive information (e.g., a sensitive topic) related to the content or a content portion, and/or the like.

In other embodiments, the sensitivity notification provider 212 can generate a sensitivity notification based on audience segment movement identified via segment movement identifier 210. In this manner, the sensitivity notification can include an indication of audience segment movement. For example, a notification can include a proportion, percent, or number of audience members that have moved from one segment to another segment (e.g., a particular other segment or any other segment). As another example, a notification can include a proportion, percent, or number of audience members that have moved within a segment or to another segment in a statistically significant amount as compared to an expected audience member movement. As another example, a notification can include an unexpected behavior modification employed by a proportion, percent, or number of audience members.

Additionally or alternatively, the sensitivity notification provider 212 can generate a sensitivity notification based on both identified sensitive content and identified audience segment movement. In this regard, in cases in which the sensitive content is identified (e.g., via sensitive content identifier 208) and audience segment movement is identified (e.g., via segment movement identifier 210), a notification can be generated. Such a notification can include any information associated with the sensitive content and/or audience segment movement.

Upon generating a sensitivity notification, the sensitivity notification provider 212 can provide the sensitivity notification, as appropriate. Sensitivity notifications can be provided to any number of type of devices, such as a user device(s) (e.g., user device 102), the sensitive topic identifier 204, the sensitive content identifier 208, among others. For instance, a sensitivity notification can be provided to a user device to notify a user (e.g., a marketer) about potential sensitive content. As described, any type of information can be provided in association with the notification, including, for example, an indication of sensitive content, a type of sensitive content, an extent or indication of audience segment movement, etc. The notification can be communicated and presented via the user device in any number of ways. For example, in some cases, an electronic message can be communicated. In other cases, an application being used to provide the content can also include a response indicating potential sensitive content associated therewith.

Additionally or alternatively to providing sensitivity notifications to a user device(s), such notifications can be provided as feedback to other components of the sensitive content manager 202. As one example, identified sensitive content (e.g., via the sensitive content identifier 208) and/or identified audience segment movement (e.g., via the segment movement identifier 210) can be provided as feedback to the sensitive topic identifier 204. Such information can be used to add new sensitive topics, refine sensitive topics, and/or weight or adjust weights of sensitive topics. For instance, in accordance with multiple identifications of a particular sensitive topic identified via the sensitive content identifier 208, a weight associated with the particular sensitive topic can be increased or incremented. A weight associated with a particular sensitive topic can also be adjusted based on identified audience segment movement (e.g., increased in cases in which a threshold level of unexpected movement is detected). Weights can be determined by any component, such as the sensitivity notification provider 212, the sensitive topic identifier 204, or other component. Weighting sensitive topics can be advantageous for machine learning training as not all sensitive topics have an equal sensitivity and, further, sensitivities associated with topics can change over time.

As another example, identified sensitive content (e.g., via the sensitive content identifier 208) and/or identified audience segment movement (e.g., via the segment movement identifier 210) can be provided as feedback to the sensitive content identifier 208. Such information can be provided as input into a machine learning model to train the model to more accurately and more comprehensively detect or predict sensitive content.

As can be appreciated, sensitivity notifications generated and provided as feedback to the sensitive content manager 202 can be of a different form or contain different information than those provided to the user device. Further, although described herein as the sensitivity notification provider 212 providing feedback, such feedback can be provided by other components. For instance, upon the sensitive content identifier 208 identifying potential sensitive content, such information can be fed back to the sensitive topic identifier 204.

Although generally described as components associated with the sensitive content manager 202 is providing feedback for enhancing performance of the sensitive content manager, feedback can be provided from any other number of sources to enhance performance of the sensitive content manager. For example, a user (e.g., a marketer) of a user device can provide feedback, such as weight indications or suggestions associated with various sensitive topics, information associated with expected audience segment movement, thresholds associated with detecting unexpected audience segment movement, etc. In this regard, as a user, or marketer, obtains information such as a flag related to sensitive content and/or audience segment movement, the user can assess the information or reassess the content and provide feedback (e.g., a new sensitive topic, a weight associated with a sensitive topic, etc.). As another example, audience member feedback (e.g., direct feedback or feedback obtained from social media comments, complaints, etc.) or other external feedback can be obtained or collected and used as feedback to input to the sensitive content manager 202.

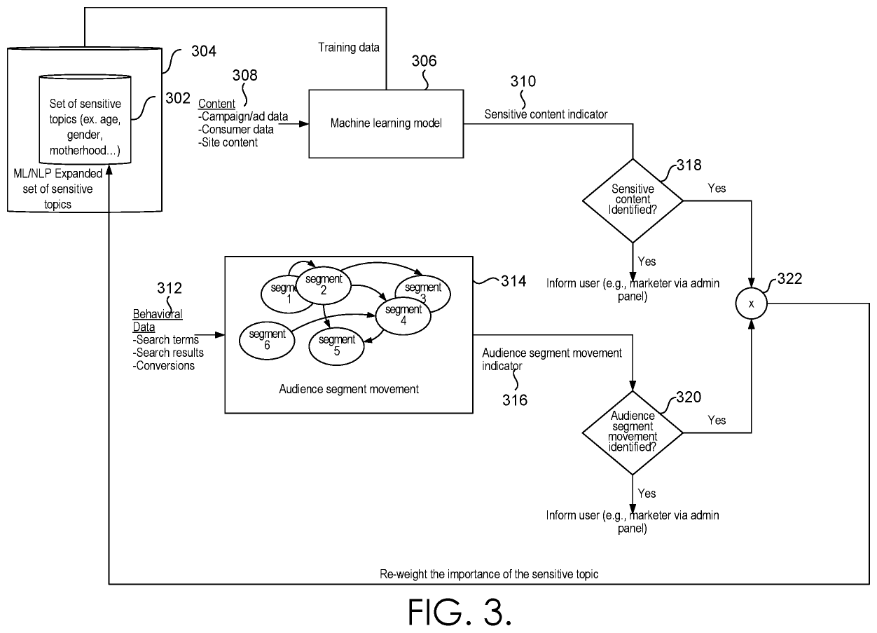

FIG. 3 provides an example flow diagram of facilitating identification of sensitive content, in accordance with embodiments described herein. As shown at block 302, a set of sensitive topics is obtained. Such an initial set of topics can be manually curated. This initial set of sensitive topics is expanded to include the expanded set of sensitive topics 304. Such sensitive topic expansion can be performed using natural language processing techniques, for example. The expanded set of sensitive topics 304 is provided as training data to train a machine learning model 306. Such a machine learning model 306 is trained to detect potential sensitive content (e.g., content presented to audience members). In this regard, content 308 is provided to the machine learning model 306 to identify or predict whether any content is sensitive. Such content 308 can include, for example, campaign or advertisement data, consumer data, website content, etc. Based on an analysis of the content, a sensitive content indicator 310 indicating either sensitive content or no sensitive content can be output. In cases that sensitive content is identified, the sensitive content indicator 310 indicates sensitive content, whereas in cases that sensitive content is not identified, the sensitive content indicator 310 indicates no sensitive content.

Assume that a user, such as a marketer, elects to publish the content. In some cases, a marketer might elect to publish content upon receiving a notification indicating that no sensitivity is identified in the content or that a sensitivity is identified in the content (but the marketer reassesses the content and elects to publish). In accordance with publishing the content, various interaction or behavioral data 312 associated with audience members (e.g., input search terms, accessed search results, conversions, etc.) can be monitored. As shown at block 314, audience segment movement, or behavioral changes, can be analyzed and determined. In accordance with analyzing audience segment movement, an audience segment movement indicator 316 can be output. In cases that audience segment movement is detected (e.g., in a statistically significant manner as compared to an expected audience segment movement), the audience segment movement indicator 316 can indicate audience segment movement, or an extent associated therewith, whereas in cases that audience segment movement is not identified (or not to a threshold extent), the audience segment movement indicator 316 can indicate no audience movement.

At block 318, a determination is made as to whether sensitive content is identified and, at block 320, a determination is made as to whether audience segment movement is identified. As shown, when sensitive content is identified (at block 318) and/or when audience segment movement is identified (at block 320), a sensitivity notification is generated and provided to a user device, such as marketer device to inform a marketer via an administrative panel. Further, as shown at 322, when both sensitive content and audience segment movement are identified, a sensitivity notification is generated and provided back to the set of sensitive topics 302. In some cases, the sensitivity notification can include adjusted weights indicating importance of sensitive topics, or including information for use in re-weighting various sensitive topics. Although FIG. 3 illustrates identifying both sensitive topics and audience segment movement to provide feedback, embodiments are not limited herein. As such, feedback can be provided in relation to identification of either sensitive content or audience member movement. Further, in cases that sensitive content is identified and/or audience segment movement is modified, such information can also be provided to a user (e.g., a marketer), for example, to provide an affirmation to the user that the content is believed to contain sensitive information and/or result in audience segment movement. Although FIG. 3 illustrates providing feedback in cases that sensitive content is identified and/or audience segment is movement is modified, embodiments are not limited herein. As such, feedback can be provided indicating sensitive content is not identified and/or audience segment movement is not modified.

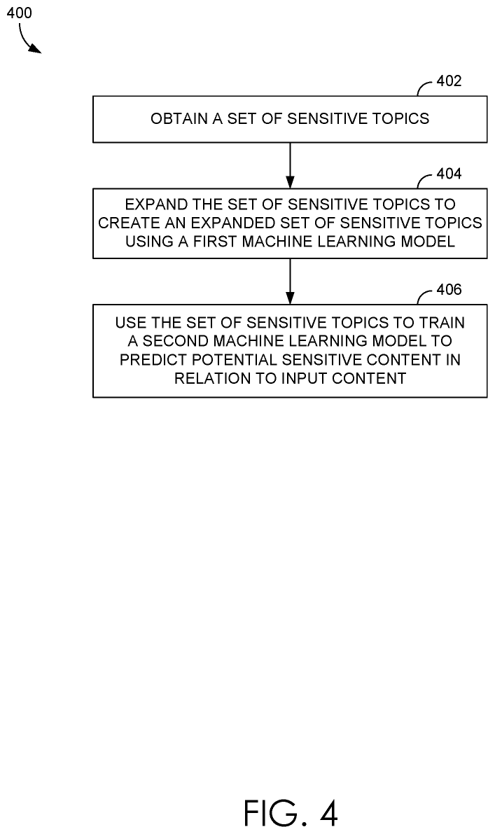

With reference now to FIGS. 4-6, FIGS. 4-6 provide method flows related to facilitating identification of sensitive content, in accordance with embodiments of the present technology. Each block of method 400, 500, and 600 comprises a computing process that can be performed using any combination of hardware, firmware, and/or software. For instance, various functions can be carried out by a processor executing instructions stored in memory. The methods can also be embodied as computer-usable instructions stored on computer storage media. The methods can be provided by a standalone application, a service or hosted service (standalone or in combination with another hosted service), or a plug-in to another product, to name a few. The method flows of FIGS. 4-6 are exemplary only and not intended to be limiting. As can be appreciated, in some embodiments, method flows 400-600 can be implemented, at least in part, to facilitate identification of sensitive content.

Turning initially to FIG. 4, a flow diagram 400 is provided showing an embodiment of a method 400 for facilitating identification of sensitive content, in accordance with embodiments described herein. Initially, at block 402, a set of sensitive topics is obtained. In embodiments, each sensitive topic in the set of sensitive topics includes subject matter that can be deemed sensitive to one or more individuals. The set of sensitive topics can be obtained in any number of ways. In some cases, the set of sensitive topics can be a manually curated set of topics.

At block 404, the set of sensitive topics is expanded to create an expanded set of sensitive topics using a first machine learning model. In some embodiments, the first machine learning model can be or include a language model. In other embodiments, the first machine learning model can be trained specifically for sensitive topic identification.

At block 406, the expanded set of sensitive topics is used to train a second machine learning model to predict potential sensitive content in relation to input content. In this regard, the trained second machine learning can subsequently take content as input and output an indication of whether the content, or a portion thereof, contains sensitive subject matter. In accordance with identifying sensitive subject matter, an indication related thereto can be provided to a user device (e.g., associated with a user that provided the content) or other component of a sensitive content manager for subsequent use (e.g., to update the set of sensitive topics, or weights associated therewith).

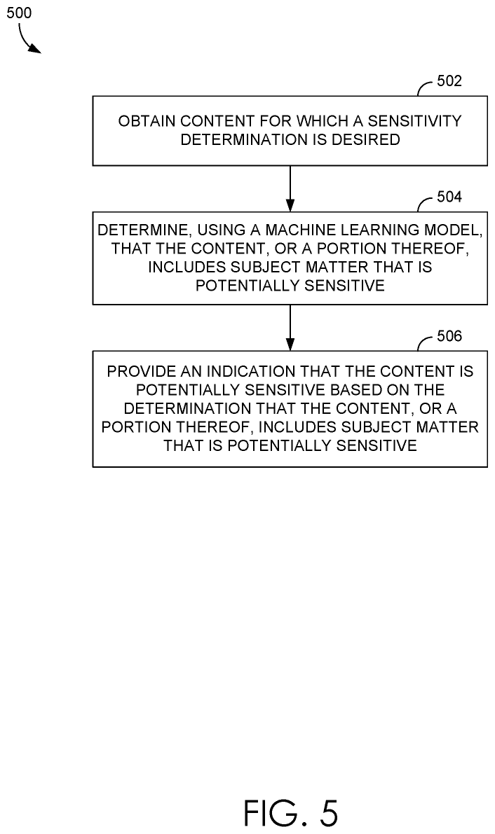

Turning now to FIG. 5, a flow diagram 500 is provided showing an embodiment of a method 500 for facilitating identification of sensitive content, in accordance with embodiments described herein. Initially, at block 502, content for which a sensitivity determination is desired is obtained. Such content can be provided by a user, such as a marketer preparing marketing content. At block 504, it is determined, using a machine learning model, that the content, or a portion thereof, includes subject matter that is potentially sensitive. Such a machine learning model can be trained using a set of sensitive topics. At block 506, based on the determination that the content, or the portion thereof, includes subject matter that is potentially sensitive, an indication that the content is potentially sensitive is provided for display to a user that provided the content. In some cases, based on such a determination, an indication that the content is potentially sensitive can also be provided for use in refining a set of sensitive topics, or weights associated therewith, used to train the machine learning model

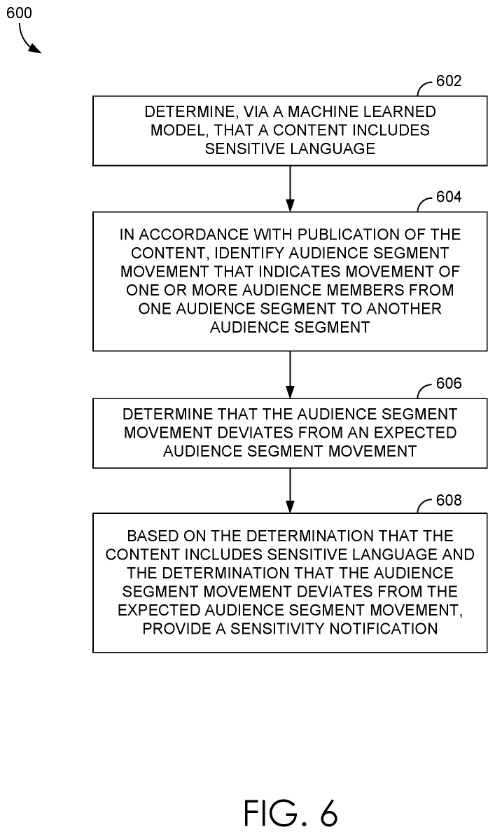

Turning now to FIG. 6, a flow diagram 600 is provided showing an embodiment of a method 600 for facilitating identification of sensitive content, in accordance with embodiments described herein. Initially, at block 602, it is determined, via a machine learned model, that a content includes sensitive language. The machine learned model can be trained using a set of sensitive topics.

At block 604, in accordance with publication of the content, audience segment movement that indicates movement of one or more audience members from one audience segment to another audience segment is identified. In embodiments, audience segment movement is identified based on monitoring audience member behavior.

At block 606, it is determined that the audience segment movement deviates from an expected audience segment movement. Such expected audience segment movement can be identified, for example, based on input provided by the user (e.g., a marketer's expectation). In embodiments, the determination that the audience segment movement deviates from an expected audience segment movement can be based on a threshold indicating a statistically significant deviation.

Thereafter, at block 608, based on the determination that the content includes sensitive language and the determination that the audience segment movement deviates from the expected audience segment movement, a sensitivity notification is provided for display to a user that provided the content. In some implementations, feedback can additionally or alternatively be provided for use in refining a set of sensitive topics, or weights associated therewith, used to train the machine learning model.

Having described embodiments of the present invention, FIG. 7 provides an example of a computing device in which embodiments of the present invention can be employed. Computing device 700 includes bus 710 that directly or indirectly couples the following devices: memory 712, one or more processors 714, one or more presentation components 716, input/output (I/O) ports 718, input/output components 720, and illustrative power supply 722. Bus 710 represents what can be one or more busses (such as an address bus, data bus, or combination thereof). Although the various blocks of FIG. 7 are shown with lines for the sake of clarity, in reality, delineating various components is not so clear, and metaphorically, the lines would more accurately be gray and fuzzy. For example, one can consider a presentation component such as a display device to be an I/O component. Also, processors have memory. The inventors recognize that such is the nature of the art and reiterate that the diagram of FIG. 7 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 7 and reference to “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media can comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 700. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 712 includes computer storage media in the form of volatile and/or nonvolatile memory. As depicted, memory 712 includes instructions 724. Instructions 724, when executed by processor(s) 714 are configured to cause the computing device to perform any of the operations described herein, in reference to the above discussed figures, or to implement any program modules described herein. The memory can be removable, non-removable, or a combination thereof. Exemplary hardware devices include solid-state memory, hard drives, optical-disc drives, etc. Computing device 700 includes one or more processors that read data from various entities such as memory 712 or I/O components 720. Presentation component(s) 716 present data indications to a user or other device. Exemplary presentation components include a display device, speaker, printing component, vibrating component, etc.

I/O ports 718 allow computing device 700 to be logically coupled to other devices including I/O components 720, some of which can be built in. Illustrative components include a microphone, joystick, game pad, satellite dish, scanner, printer, wireless device, etc. I/O components 720 can provide a natural user interface (NUI) that processes air gestures, voice, or other physiological inputs generated by a user. In some instances, inputs can be transmitted to an appropriate network element for further processing. An NUI can implement any combination of speech recognition, touch and stylus recognition, facial recognition, biometric recognition, gesture recognition both on screen and adjacent to the screen, air gestures, head and eye tracking, and touch recognition associated with displays on computing device 700. Computing device 700 can be equipped with depth cameras, such as stereoscopic camera systems, infrared camera systems, RGB camera systems, and combinations of these, for gesture detection and recognition. Additionally, computing device 700 can be equipped with accelerometers or gyroscopes that enable detection of motion. The output of the accelerometers or gyroscopes can be provided to the display of computing device 700 to render immersive augmented reality or virtual reality.

Embodiments presented herein have been described in relation to particular embodiments which are intended in all respects to be illustrative rather than restrictive. Alternative embodiments will become apparent to those of ordinary skill in the art to which the present disclosure pertains without departing from its scope.

Various aspects of the illustrative embodiments have been described using terms commonly employed by those skilled in the art to convey the substance of their work to others skilled in the art. However, it will be apparent to those skilled in the art that alternate embodiments can be practiced with only some of the described aspects. For purposes of explanation, specific numbers, materials, and configurations are set forth in order to provide a thorough understanding of the illustrative embodiments. However, it will be apparent to one skilled in the art that alternate embodiments can be practiced without the specific details. In other instances, well-known features have been omitted or simplified in order not to obscure the illustrative embodiments.

Various operations have been described as multiple discrete operations, in turn, in a manner that is most helpful in understanding the illustrative embodiments; however, the order of description should not be construed as to imply that these operations are necessarily order dependent. In particular, these operations need not be performed in the order of presentation. Further, descriptions of operations as separate operations should not be construed as requiring that the operations be necessarily performed independently and/or by separate entities. Descriptions of entities and/or modules as separate modules should likewise not be construed as requiring that the modules be separate and/or perform separate operations. In various embodiments, illustrated and/or described operations, entities, data, and/or modules can be merged, broken into further sub-parts, and/or omitted.

The phrase “in one embodiment” or “in an embodiment” is used repeatedly. The phrase generally does not refer to the same embodiment; however, it can. The terms “comprising,” “having,” and “including” are synonymous, unless the context dictates otherwise. The phrase “A/B” means “A or B.” The phrase “A and/or B” means “(A), (B), or (A and B).” The phrase “at least one of A, B and C” means “(A), (B), (C), (A and B), (A and C), (B and C) or (A, B and C).”

What is claimed is:

1. A computer-implemented method comprising:
obtaining, via a sensitive topic identifier, a set of sensitive topics, wherein each sensitive topic in the set of sensitive topics includes subject matter that may be deemed sensitive to one or more individuals;
expanding, via a sensitive topic expander, the set of sensitive topics to an expanded set of sensitive topics using a first machine learning model;
using the expanded set of sensitive topics to train, via a sensitive content identifier, a second machine learning model to predict potential sensitive content in relation to input content.

2. The computer-implemented method of claim 1, wherein the set of sensitive topics is obtained based on feedback from a domain expert.

3. The computer-implemented method of claim 1, wherein the first machine learning model comprises a language model.

4. The computer-implemented method of claim 1, wherein the first machine learning model is trained specifically in relation to sensitive topics.

5. The computer-implemented method of claim 1, wherein the set of sensitive topics includes topics identified via application of the second machine learning model to a new content.

6. The computer-implemented method of claim 1 further comprising:
obtaining a new content;
using the trained second machine learning model to identify that the new content includes sensitive content; and
providing an indication of the sensitive content to a user device.

7. The computer-implemented method of claim 1, further comprising:
obtaining a new content;
using the trained second machine learning model to identify that the new content includes sensitive content; and
providing an indication of the sensitive content for use in updating the set of sensitive topics, or weights associated therewith.

8. One or more computer-readable media having a plurality of executable instructions embodied thereon, which, when executed by one or more processors, cause the one or more processors to perform a method comprising:
obtaining content for which a sensitivity determination is desired;
determining, using a machine learning model, that the content, or a portion thereof, includes subject matter that is potentially sensitive; and
based on the determination that the content, or the portion thereof, includes subject matter that is potentially sensitive, providing an indication that the content is potentially sensitive for display to a user that provided the content.

9. The media of claim 8, wherein the machine learning model is trained using a set of sensitive topics.

10. The media of claim 8, wherein based on the determination that the content, or the portion thereof, includes subject matter that is potentially sensitive, further providing an indication that the content is potentially sensitive for use in refining a set of sensitive topics, or weights associated therewith, used to train the machine learning model.

11. The media of claim 8, wherein the method further comprises:
determining audience segment movement in association with publication of the content; and
based on the determination of the audience segment movement and the determination that the content, or the portion thereof, includes subject matter that is potentially sensitive, providing at least one sensitivity notification for use in refining a set of sensitive topics, or weights associated therewith, used to train the machine learning model.

12. The media of claim 8, wherein the method further comprises:
determining a statistically significant audience segment movement in comparison to an expected audience segment movement upon publication of the content; and
based on the determination of the statistically significant audience segment movement and the determination that the content, or the portion thereof, includes subject matter that is potentially sensitive, providing at least one sensitivity notification to the user that provided the content, wherein the at least one sensitivity notification indicates the statistically significant audience segment movement and/or the potentially sensitive content.

13. The media of claim 8, wherein the machine learning model outputs a probability associated with the potential sensitivity.

14. The media of claim 8, wherein the indication that the content is potentially sensitive includes an indication of a particular sensitive topic identified within the content.

15. The media of claim 8, wherein the content comprises advertising or marketing material.

16. A computing system comprising:
a processor; and
a non-transitory computer-readable medium having stored thereon instructions that when executed by the processor, cause the processor to perform operations including:
determining, via a machine learned model, that a content includes sensitive language;
in accordance with publication of the content, identifying audience segment movement that indicates movement of one or more audience members from one audience segment to another audience segment;
determining the audience segment movement deviates from an expected audience segment movement; and
based on the determination that the content includes sensitive language and the determination that the audience segment movement deviates from the expected audience segment movement, providing a sensitivity notification for display to a user that provided the content.

17. The system of claim 16, wherein the expected audience segment movement is identified based on input provided by the user.

18. The system of claim 16, wherein the audience segment movement is identified based on monitoring audience member behavior.

19. The system of claim 16, wherein the determination that the audience segment movement deviates from the expected audience segment movement is determined using a threshold indicating a statistically significant deviation.

20. The system of claim 16, wherein feedback is provided for use in refining a set of sensitive topics, or weights associated therewith, used to train the machine learning model based on the determination that the content includes sensitive language and the determination that the audience segment movement deviates from the expected audience segment movement.
